(19) United States
(12) Patent Application Publication
(10) Pub. No.: US 2022/0297449 A1
(43) Pub. Date: Sep. 22, 2022

(54) AN APPARATUS FOR DIGITAL PRINTING OF CARTON-BASED PACKAGING MATERIAL FOR PACKAGES HOLDING LIQUID FOOD PRODUCTS AND A METHOD THEREOF

(71) Applicant: Tetra Laval Holdings & Finance S.A., (US)

(72) Inventors: Mats ÅKESSON, Malmö (SE); Anna HARDER, Hjärup (SE); Roy EIDEBAKKEN, Veberöd (SE); Daniel CEDERSTRÖM, Limhamn (SE); Mats QVARFORD, Lund (SE)

(21) Appl. No.: 17/609,020

(22) PCT Filed: May 6, 2020
(86) PCT No.: PCT/EP2020/062510

§ 371 Date: Nov. 5, 2021

(30) Foreign Application Priority Data
May 14, 2019 (EP) 19174364.0

(51) Int. Cl. B41J 11/00; B41J 15/16; B41M 5/00; B65B 61/02

(52) U.S. Cl. CPC B41J 11/00214; B41J 11/00218; B41J 15/16; B41M 5/0047; B41M 5/0064; B65B 61/025

(57) ABSTRACT

An apparatus for digital printing of carton-based packaging material for packages holding liquid food products is presented. The packaging material has a first side adapted to form outer surfaces of the packages and a second side adapted to form inner surfaces of the packages. The apparatus includes an inlet configured to receive a web of the packaging material with a normal vector of the first side directed in a first direction a web feeding assembly arranged to feed the web from the inlet and through the apparatus, wherein the web feeding assembly includes at least one drive unit and at least one web direction device, a number of print bars provided with print heads arranged to provide food graded ink on the first side of the web, wherein the web feeding assembly is arranged to turn the web after being received via the inlet such that the normal vector of first side is directed in a second direction and the first side is facing the print heads, a number of curing devices provided with curing heads arranged for curing the food graded ink provided on the first side, wherein the web feeding assembly is arranged to turn the web after the food graded ink has been provided by the print heads such that the normal vector of the first side is directed in a third direction and the first side is facing the curing heads, an outlet configured to transfer the web of packaging material out of the apparatus.

### TECHNICAL FIELD

The invention generally relates to the field of packaging technology, such as food packaging technology. More particularly, it is presented methods and apparatuses for digital printing of carton-based packaging material for packages holding liquid food products.

### BACKGROUND ART

Today it is commonly known to use roll-fed packaging machines for different types of food products, e.g. milk. The roll-fed packaging machines, also referred to as filling machines, have several advantages. One is that a continuous production of packages makes it possible to achieve higher speeds compared to blanks-fed packaging systems. Another advantage is that by continuously filling a tube of packaging material and forming packages in a lower end of the tube, a risk that unwanted microorganisms enter the packages can be lowered.

The packaging material is today most often printed using so-called flexography in packaging material production centers, sometimes also referred to as converting factories, for carton-based packaging material. After being printed and in other ways prepared for holding food products, for example being laminated such that an inner plastic layer is formed between a carton layer of the packaging material and the food product, the packaging material is loaded on to a reel and shipped to a site where a packaging machine is placed.

Instead of having the packaging material printed, e.g. by using flexography, and prepared in the packaging material production centers, it has been suggested to use digital printing for printing the packaging material. An advantage of using digital printing instead of flexography is that smaller batches may be printed in a cost efficient manner.

Even though it is known to use digital printing for printing the packaging material, there is a number of challenges that needs to be overcome. One of these challenges is to design the apparatus for digital printing such that this may be added to existing lines without requiring costly modifications and rebuilding of the packaging machine and or the building, in which the packaging machine is placed.

### SUMMARY

It is an object to at least partly overcome one or more of the above-identified limitations of the prior art. In particular, it is an object to provide an apparatus for digital printing of packaging material that is designed in a compact manner that can be added to an existing packaging machine with no or few modifications required.

According to a first aspect it is provided an apparatus for digital printing of carton-based packaging material for packages holding liquid food products, wherein the packaging material has a first side adapted to form outer surfaces of the packages and a second side adapted to form inner surfaces of the packages, the apparatus comprising an inlet configured to receive a web of the packaging material with a normal vector of the first side directed in a first direction a web feeding assembly arranged to feed the web from the inlet and through the apparatus, wherein the web feeding assembly comprises at least one drive unit and at least one web direction device, a number of print bars provided with print heads arranged to provide food graded ink on the first side of the web, wherein the web feeding assembly is arranged to turn the web after being received via the inlet such that the normal vector of first side is directed in a second direction and the first side is facing the print heads, a number of curing devices provided with curing heads arranged for curing the food graded ink provided on the first side, wherein the web feeding assembly is arranged to turn the web after the food graded ink has been provided by the print heads such that the normal vector of the first side is directed in a third direction and the first side is facing the curing heads, an outlet configured to transfer the web of packaging material out of the apparatus.

The print heads of the number of print bars may be facing downwards, and/or the curing heads of the curing devices may be facing upwards.

The apparatus may further comprise a shielding arrangement physically separating the print heads and the curing heads such that energy emitted from the curing heads is hindered from reaching the print heads.

The shielding arrangement may form part of a web tension arrangement that can provide for that the web is tensioned when the ink is provided by the number of print bars and/or when the ink is cured by the number of curing devices.

At least part of the number of print bars may be placed above at least part of the number of curing devices.

The web feeding assembly may be arranged such that a first slack of the web is formed downstream the inlet and upstream the number of print bars, and/or such that a second slack of the web is formed downstream the number of curing devices and upstream the outlet.

The curing heads may be ultraviolet (UV) lights.

According to a second aspect it is provided a method for digital printing of carton-based packaging material for packages holding liquid food products, wherein the packaging material has a first side adapted to form outer surfaces of the packages and a second side adapted to form inner surfaces of the packages, the method comprising receiving a web of the packaging material with a normal vector of the first side directed in a first direction via an inlet, feeding the web from the inlet and through the apparatus by using a web feeding assembly from the inlet and through the apparatus, wherein the web feeding assembly comprises at least one drive unit and at least one web direction device, redirecting the web after being received via the inlet such that the normal vector of the first side is directed in a second direction and the first side is facing print heads of a number of print bars, providing food graded ink on the first side of the web by using the number of print bars provided with the print heads, redirecting the web after the food graded ink has been provided by the print heads such that the normal vector of the first side is directed in a third direction and the first side is facing curing heads of a number of curing devices, curing the food graded ink provided on the first side by using the number of curing devices provided with the curing heads, and transferring the web out of the apparatus via an outlet.

The print heads of the number of print bars may be facing downwards, and/or the curing heads of the curing devices may be facing upwards.

The method may further comprise hindering energy emitted from the curing heads from reaching the print heads by using a shielding arrangement physically separating the print heads and the curing heads.

The method may further comprise tensioning the web when the ink is provided by the number of print bars and/or when the ink is cured by the number of curing devices by using a web tension arrangement, wherein the shielding arrangement forms part of a web tension arrangement.

At least part of the number of print bars may be placed above at least part of the number of curing devices.

The method may further comprise compensating for variations in speed in the apparatus by forming a first slack downstream the inlet and upstream the number of print bars by using the web feeding assembly, and/or by forming a second slack downstream the number of curing devices and upstream the outlet by using the web feeding assembly.

The curing heads may be ultraviolet (UV) lights.

According to a third aspect it is provided a computer program product comprising instructions which, when executed on a computer, cause the computer to carry out the method according to the first aspect.

Still other objectives, features, aspects and advantages will appear from the following detailed description as well as from the drawings.

### BRIEF DESCRIPTION OF THE DRAWINGS

Embodiments will now be described, by way of example, with reference to the accompanying schematic drawings, in which

FIG. 1 is a general illustration of a roll-fed packaging machine.

FIGS. 2a and 2b are side views of two embodiments of an apparatus for digital printing of carton-based packaging material for packages holding liquid food products.

FIG. 3 is a flow chart illustrating a method for digital printing of carton-based packaging material.

### DETAILED DESCRIPTION

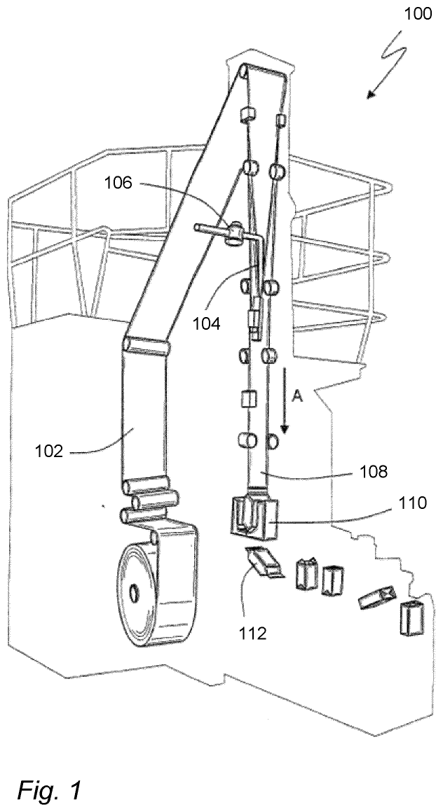

With reference to FIG. 1, a packaging machine 100, sometimes also referred to as a filling machine, is generally illustrated by way of example. The packaging machine 100 is a roll-fed packaging machine used for packaging liquid food products in carton-based packages. Already in the 1940s this type of packaging machines was introduced by Tetra Pak, and it is today a well-known approach for packaging milk and other liquid food products in a safe and cost-efficient manner. The general approach can also be used for non-liquid food products, such as potato crisps.

Today, packaging material is often printed and prepared in packaging material production centers, also referred to as converting factories, and is shipped to a site where the packaging machine 100 is placed, e.g. a dairy. Usually the packaging material is loaded onto a reel before being transported. After arriving at the site, the reel is placed in the packaging machine as illustrated in FIG. 1.

During production a web 102 of packaging material can be fed from the reel through the packaging machine in a web feeding direction A. Even though not illustrated in FIG. 1, the packaging material may pass through a sterilization device, e.g. a hydrogen peroxide bath or an LVEB (Low-Voltage Electron Beam) station, for ensuring that the web 102 is free from unwanted microorganisms. Before providing the food product, a tube can be formed from the web 102 by forming a longitudinal sealing. The food product can be fed into the tube via a pipe 104 and a valve 106 may be used for regulating a flow through the pipe 104. A lower end 108 of the tube can be fed into a folding device 110 in which a transversal sealing is made, the tube is folded according to folding lines, also referred to as weakening lines or creasing lines, and cut off such that packages 112 can be formed. Even though the folding device 110 is illustrated as one single device, the folding device 110 may comprise a number of different devices.

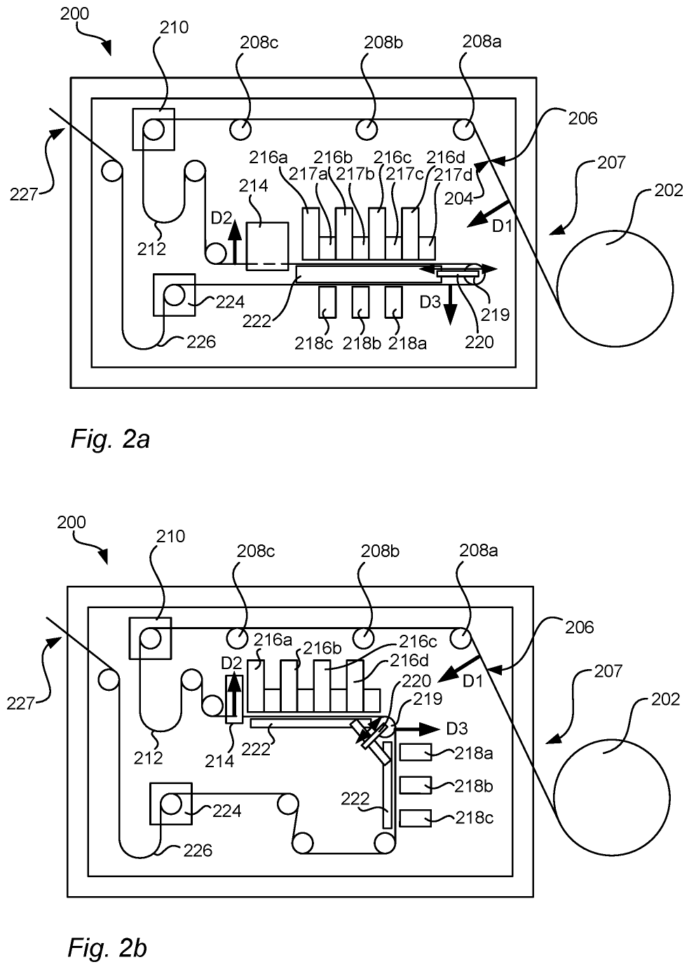

Instead of having the web 102 of packaging material printed in packaging material production centers, i.e. off-site printed, the web 102 can be printed on-site using e.g. digital printing in an apparatus 200 as illustrated in FIGS. 2a and 2b. The apparatus 200 can be arranged such that the web 102 is fed via the apparatus 200 into the packaging machine 100.

Packaging material may be fed into the apparatus 200 via a reel 202. The packaging material may be partly printed, i.e. sections of the packaging material is printed in packaging material production centers, or the packaging material may be without printing, such that all printing is made by the apparatus 200.

The packaging material may be loaded on to the reel 202 such that a first side 204, adapted to form outer surfaces of the packages 112, is facing outwards, and a second side 206, adapted to form inner surfaces of the packages 112, is facing inwards. The web 102 can be fed into the apparatus 200 via an inlet 207 with the first side 204 facing downwards.

In the apparatus 200, the web 102 may be fed forward by a web feeding assembly. The web feeding assembly may comprise a first roller 208a, a second roller 208b, a third roller 208c or any other type of web direction device, and a first drive unit 210 that together is providing for that the web is fed through the apparatus 200 as well as unloaded from the reel 202. To be able to compensate for that different steps in the apparatus 200 may require different amounts of time at different occasions, the web 102 may form a first slack 212 downstream the first drive unit 210. The first slack 212 may be formed between the inlet 207 and a pre-treatment device 214.

From the first slack 212, the web 102 may be fed into the pre-treatment device 214 in which the packaging material is pre-treated such that printing can be made in subsequent stations downstream the pre-treatment device 214. As illustrated, the printing may be provided by using a number of print bars, herein by example four print bars 216a, 216b, 216c, 216d, in combination with a number of pinning devices providing for an initial curing, herein by example four pinning devices 217a, 217b, 217c, 217d. The print bars 216a, 216b, 216c, 216d can be provided with print heads that is facing downwards such that these can provide for that the first side 204 is printed with food graded ink when passing the print bars.

As illustrated in FIG. 2a, after being printed the web can be turned such that the first side 204 is facing downwards. By using a number of curing devices, herein by example three curing devices 218a, 218b, 218c, the food graded ink provided by the print bars 216a, 216b, 216c, 216d can be cured. The curing devices 218a, 218b, 218c can be provided with curing heads facing upwards such that the curing heads are facing the first side 204 of the packaging material. The curing devices 218a, 218b, 218c can be an energy curing for example electron beam or UV light.

The web 102 may be turned by using a fourth roller 219, or any other type of web direction device, placed downstream the print bars 216a, 216b, 216c, 216d and upstream the curing devices 218a, 218b, 218c. The fourth roller 219 may form part of a web tension arrangement 220 that can be used to provide for that the web 102 is tensioned when printing, pinning and/or curing, and/or the fourth roller 219 may form part of the web feeding assembly.

The web tension arrangement 220 may comprise a shielding arrangement 222 that is hindering emission, for example the UV light, from the curing devices 218a, 218b, 218c from reaching the print heads of the print bars 216a, 216b, 216c, 216d. The shielding arrangement 222 may e.g. be metal plates placed between the curing heads and the print heads.

The web tension arrangement 220 may be embodied in various ways. By way of example, as illustrated in FIGS. 2a and 2b, the web 102 may be tensioned by moving the fourth roller 219 such that the web is tensioned or loosened.

After being cured, the web 102 can be fed via a second drive unit 224, that can form part of the web feeding assembly, to a second slack 226 and thereafter out of the apparatus 200 via an outlet 227. An advantage with the second slack 224 is that this makes it possible to compensate for minor stops in the packaging machine 100 placed downstream, as well as speed variations within the apparatus 200.

A general advantage with the apparatus 200 is that the print bars 216a, 216b, 216c, 216d may be placed above the curing devices 218a, 218b, 218c, which provides for that a compact design can be achieved. Further, by redirecting the web twice the packaging material can be provided in the same manner as of today, i.e. provided on the reel 202 with the first side 204 facing outwards, and also the packaging machine 100 can be provided in the same manner as of today, i.e. receiving the web with the first side 204 facing downwards. Another advantage with the design is therefore that few or no modifications are required in the packaging machine 100 and in the packaging material production centers.

As illustrated in FIG. 2a and as explained above, the web 102 may be turned 180 degrees after passing the print heads and before passing the curing heads such that e.g. the printer bars 216a, 216a, 216c, 216d can be placed above the curing devices 218a, 218b, 218c. Put differently, a normal vector of the first side 204 may be directed in a first direction D1 when being fed into the apparatus 200 via the inlet 207. By using the web feeding assembly the web 102 may be redirected such that the normal vector is directed in a second direction D2 when reaching the print heads of the printer bars 216a, 216b, 216c, 216d. After printing, i.e. downstream the print heads, the web 102 may be redirected such that the normal vector of the first side 204 is directed in a third direction D3. If having the printer bars placed above the curing devices as illustrated in FIG. 2a, the second direction D2 and the third direction D3 may represent two opposite directions, i.e. 180 degrees apart from each other.

FIG. 2b illustrates another example of how the apparatus may be designed. In the example illustrated in FIG. 2b, the printer bars 216a, 216b, 216c, 216d may placed such that the print heads are facing downwards, in line with the print heads of the apparatus 200 illustrated in FIG. 2a, but unlike the apparatus 200 illustrated in FIG. 2a, the curing devices 218a, 218b, 218c are placed such that the curing heads are facing horizontally such that the web 102 may be cured while this is moving vertically, more particularly, in this example, downwards. Put differently, instead of redirecting the web 102 such that the normal vector of the first side 204 is shifted 180 degrees, as illustrated in FIG. 2a, the normal vector is redirected 90 degrees.

Further, even though not illustrated, it is also possible to have both the print bars 216a, 216b, 216c, 216d and the curing devices 218a, 218b, 218c horizontally placed and opposite to each other, and redirecting the web 180 degrees downstream the printer bars 216a, 216b, 216c, 216d and upstream the curing devices 218a, 218b, 218c.

Even though the examples above are related to redirecting the normal vector downstream the printer heads and upstream the curing heads 90 or 180 degrees, it is to be understood that this only examples and that the web 102 may be directed not only according to these specified examples, e.g. in several minor steps of less than 90 degrees.

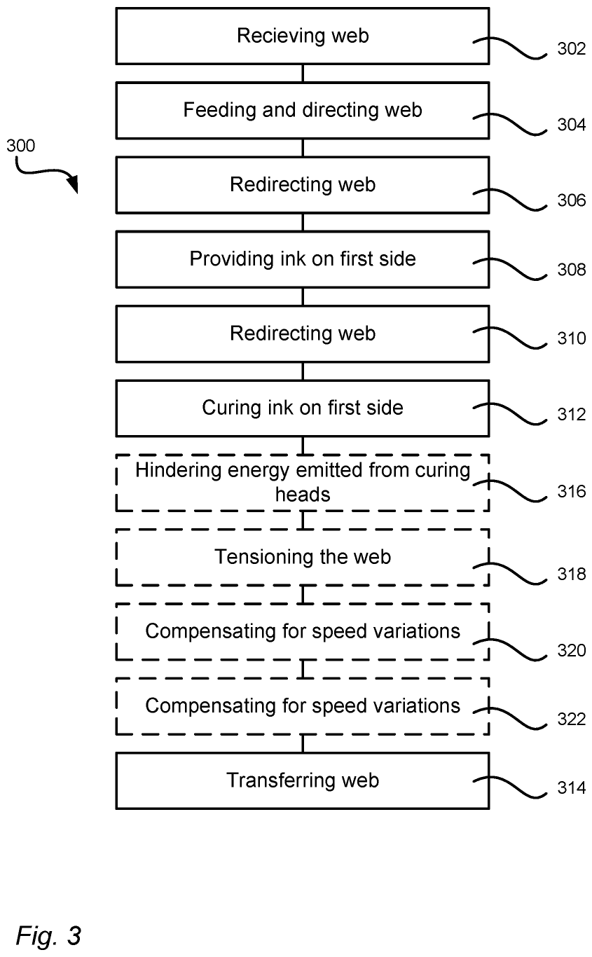

In FIG. 3 it is presented a flowchart illustrating a method for digital printing of carton-based packaging material for packages 112 holding liquid food products by way of example. In a first step 302 the web 102 can be received with the normal vector of the first side 204 directed in the first direction D1. In a second step 304, the web can be fed through the apparatus 200. In a third step 306, the web 102 can be redirected such that the normal vector of the first side is directed in a second direction D2. In a fourth step 308, the ink can be provided on the first side 204 by print bars 216a, 216b, 216c, 216d provided with the print heads. Thereafter, in a fifth step 310, the web 102 can be redirected such that the normal vector of the first side is directed in a third direction D3. In a sixth step 312, the ink provided on the first side 204 can be cured by the curing devices 218a, 218b, 218c provided with the curing heads. In a seventh step 314, the web can be transferred out from the apparatus 200.

Optionally, in an eighth step 316, energy emitted from the curing devices 318a, 318b, 318c may be hindered from reaching the print heads by the shielding arrangement 222.

Optionally, in a ninth step 318, the web can be tensioned during printing and/or curing by the web tension arrangement 220. The shielding arrangement 222 may form part of this web tension arrangement 220.

Optionally, in a tenth step 320, the first slack 212 can formed such that variations in speed in the apparatus 200 can be compensated for.

Optionally, in an eleventh step 322, the second slack 226 can be formed such that variations in speed in the apparatus 200 can be compensated for.

Even if described in a specific order it is to be understood that the steps do not have to be performed in this order.

From the description above follows that, although various embodiments of the invention have been described and shown, the invention is not restricted thereto, but may also be embodied in other ways within the scope of the subject-matter defined in the following claims.

1. An apparatus for digital printing of carton-based packaging material for packages holding liquid food products,
wherein the packaging material has a first side adapted to form outer surfaces of the packages and a second side adapted to form inner surfaces of the packages,
the apparatus comprising
an inlet configured to receive a web of the packaging material with a normal vector of the first side directed in a first direction
a web feeding assembly arranged to feed the web from the inlet and through the apparatus
wherein the web feeding assembly comprises at least one drive unit and at least one web direction device,
a number of print bars provided with print heads arranged to provide food graded ink on the first side of the web,
wherein the web feeding assembly is arranged to turn the web after being received via the inlet such that the normal vector of first side is directed in a second direction and the first side is facing the print heads,
a number of curing devices provided with curing heads arranged for curing the food graded ink provided on the first side,
wherein the web feeding assembly is arranged to turn the web after the food graded ink has been provided by the print heads such that the normal vector of the first side is directed in a third direction and the first side is facing the curing heads,
an outlet configured to transfer the web of packaging material out of the apparatus.

2. The apparatus according to claim 1, wherein the print heads of the number of print bars are facing downwards, and/or the curing heads of the curing devices are facing upwards.

3. The apparatus according to claim 1, further comprising
a shielding arrangement physically separating the print heads and the curing heads such that energy emitted from the curing heads is hindered from reaching the print heads.

4. The apparatus according to claim 3, wherein the shielding arrangement forms part of a web tension arrangement that provides for that the web is tensioned when the ink is provided by the number of print bars and/or when the ink is cured by the number of curing devices.

5. The apparatus according to claim 1, wherein at least part of the number of print bars are placed above at least part of the number of curing devices.

6. The apparatus according to claim 1, wherein the web feeding assembly is arranged such that a first slack of the web is formed downstream the inlet and upstream the number of print bars, and/or such that a second slack of the web is formed downstream the number of curing devices and upstream the outlet.

7. The apparatus according to claim 1, wherein the curing heads are ultraviolet (UV) lights.

8. A method for digital printing of carton-based packaging material for packages holding liquid food products,
wherein the packaging material has a first side adapted to form outer surfaces of the packages and a second side adapted to form inner surfaces of the packages,
the method comprising
receiving a web of the packaging material with a normal vector of the first side directed in a first direction via an inlet,
feeding the web from the inlet and through the apparatus by using a web feeding assembly from the inlet and through the apparatus, wherein the web feeding assembly comprises at least one drive unit and at least one web direction device,
redirecting the web after being received via the inlet such that the normal vector of the first side is directed in a second direction and the first side is facing print heads of a number of print bars,
providing food graded ink on the first side of the web by using the number of print bars provided with the print heads,
redirecting the web after the food graded ink has been provided by the print heads such that the normal vector of the first side is directed in a third direction and the first side is facing curing heads of a number of curing devices,
curing the food graded ink provided on the first side by using the number of curing devices provided with the curing heads, and transferring the web out of the apparatus via an outlet.

9. The method according to claim 8, wherein the print heads of the number of print bars are facing downwards, and/or the curing heads of the curing devices are facing upwards.

10. The method according to claim 8, further comprising
hindering energy emitted from the curing heads from reaching the print heads by using a shielding arrangement physically separating the print heads and the curing heads.

11. The method according to claim 10, further comprising tensioning the web when the ink is provided by the number of print bars and/or when the ink is cured by the number of curing devices by using a web tension arrangement, wherein the shielding arrangement forms part of a web tension arrangement.

12. The method according to claim 8, wherein at least part of the number of print bars are placed above at least part of the number of curing devices.

13. The method according to claim 8, further comprising
compensating for variations in speed in the apparatus by forming a first slack downstream the inlet and upstream the number of print bars by using the web feeding assembly and/or by forming a second slack downstream the number of curing devices and upstream the outlet by using the web feeding assembly.

14. The method according to claim 8, wherein the curing heads are ultraviolet (UV) lights.

15. A computer program product comprising instructions which, when executed on a computer, cause the computer to carry out the method of claim 8.
